(19) United States
(12) Patent Application Publication
(10) Pub. No.: US 2007/0095818 A1
(43) Pub. Date: May 3, 2007

(54) Method of processing parallel resistance electrical heating cable

(75) Inventor: Jason Daniel Harold O'Connor, Glossop (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Heatsafe Cable Systems Limited, Helsby (GB)

(21) Appl. No.: 10/572,414

(22) PCT Filed: Sep. 10, 2004
(86) PCT No.: PCT/GB04/03860

§ 371 Date: Mar. 16, 2006

(30) Foreign Application Priority Data
Sep. 30, 2003 (GB) 0322047.2

(51) Int. Cl. H05B 1/02

(52) U.S. Cl. 219/494; 219/504

(57) ABSTRACT

A method of processing a parallel resistance heating cable is described. The cable comprises a heating element connected between two longitudinally extending conductors. The method comprises applying a current along at least one of the conductors, such that the surface temperature of the conductor is raised by ohmic heating to substantially the thermal transition point that allows plastic flow of the heating element. This step is for improving the bond between the conductors and the heating element.

The present invention relates to parallel resistance heating cables, and in particular to a method suitable for, but not limited to, repairing failed parallel resistance heating cable including failed self regulating parallel resistance cable. The method can also be used to improve the manufacture of such cable.

Heating cables fall into two general categories, that is parallel resistance types and series resistance types. Series resistance heating cables typically comprise one or more longitudinally extending resistance wires embedded in insulation selected to withstand the operating temperatures of the cable.

In parallel resistance cable types, generally two insulated conductors (known as buswires) extend longitudinally along the cable. A resistive heating element is in contact with both buswires.

The parallel heating element typically takes one of two forms. The element may be a resistance heating wire spiralled around the conductors, with electrical connections being made alternatively at intervals along the longitudinally extending conductors. This creates a series of short heating zones spaced apart along the length of the cable. The heating wire must be selectively insulated from the conductors, and also encased within an insulating sheath.

Alternatively, the heating element may take the form of an extruded matrix extending between, and in electrical contact with, the two conductors. Often, semiconductors are selected for the heating element that have a positive temperature coefficient. Thus as the temperature of the element increases, the resistance of the material electrically connected between the conductors increases, thereby reducing power output. Such heating cables, in which the power output varies according to temperature, are said to be self-regulating or self-limiting.

FIG. 1 illustrates a typical parallel resistance self-regulating heating cable 2. The cable consists of a semi-conductive polymeric matrix 8 extruded around the two parallel conductors 4, 6. The matrix 8 serves as the heating element. A polymeric insulator jacket 10 is then extruded over the matrix 8. Typically a conductive outer braid 12 (e.g. a tinned copper braid) is added for additional mechanical protection and/or use as an earth wire. Such a braid is typically covered by a thermoplastic overjacket 14 for additional mechanical and corrosive protection.

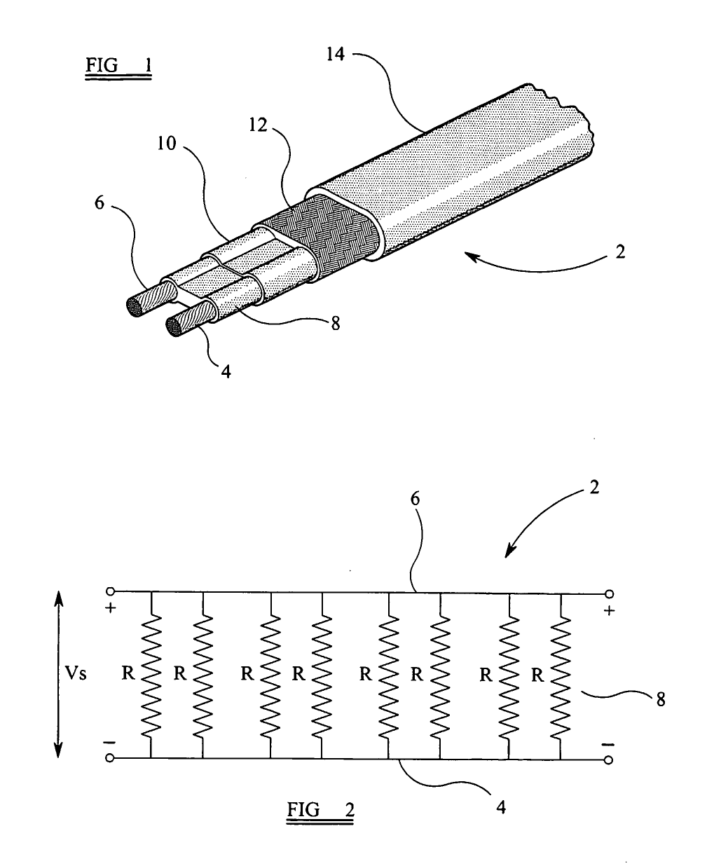

FIG. 2 is a schematic diagram indicating the effective circuit provided by the parallel resistance type cable 2 shown in FIG. 1. In functional terms, the heating element 8 can be envisaged as effectively a series of resistors R connected in parallel between the two conductors 4, 6. In operation, a voltage V_{S} is applied across the conductors 4, 6, with the cable providing heat due to the subsequent ohmic heating of the heating element material 8.

The most common failure mode of parallel resistance self-regulating heaters is loss of, or reduction in, electrical contact between the power conductors and the extruded semi-conductive matrix forming the heating element. For example, differential expansion of the components and thermal cycling may lead to such a failure or reduction in electrical contact. Such a reduction leads to electrical arcing within the cable, and a consequent decrease in thermal output. The operational life of the product is thus dependant upon the bond between the conductors and the heating element.

Clearly a key element in the production of the cable is in ensuring a good bond is formed. This is done by matching as closely as possible the temperatures of the conductors and the molten semi-conductor during extrusion of the semi-conductor. The conductors are therefore pre-heated by an external heater to the melting temperature of the semi-conductor (typically 180° C.-200° C. for low temperature self-regulating cables). Controlled cooling of the cable (i.e. the conductors embedded within the extruded semi-conductive matrix) is then utilised to produce a good bond.

Deterioration of the bond between the heating element and the conductors can lead to either deterioration in the performance of a cable (a reduction in power output of the heating cable), or in extreme cases, complete failure of the cable. In either instance, replacement of the cable may be required. This can be a relatively expensive and time consuming operation, particularly in large installations. For instance, if the cable is utilised to provide under floor heating, then the floor surface may need to be dug up. Alternatively, if the cable is utilised to keep pipes warm, then the additional thermal insulation layer that typically surrounds the pipe and the cable will also need to be removed.

It is an object of the present invention to provide a method of processing a self-regulating or other extruded element, parallel resistance heating cable that substantially obviates or mitigates one or more problems of the prior art, whether referred to herein or otherwise.

According to a first aspect, the present invention provides a method of processing a parallel resistance heating cable, the cable comprising a heating element connected between at least two longitudinally extending conductors, the method comprising applying a current along at least one of said conductors, such that the surface temperature of the conductor is raised by ohmic heating to at least substantially the thermal transition point that allows plastic flow of the heating element.

This ohmic heating is used to improve the bond between the conductors and the heating element.

A current may be applied along each of said conductors so as to raise the surface temperature of each conductor to at least substantially the thermal transition point of the heating element.

The method may comprise connecting said conductors in series prior to applying said current.

The current may be applied so as to elevate the surface of said conductor to a temperature greater than the thermal transition point of the heating element.

The current may be applied for a time period of between 0.1 and 60 seconds.

The method may further comprise the step of allowing the cable to cool to substantially ambient temperature after the application of said current.

The method may further comprise the step of monitoring the integrity of the bond between the conductors and the heating element by determining the resistance between the conductors when at least two different voltages are applied across the conductors.

The method further comprising the step of determining that the performance of the heating cable is less than optimum.

The method steps may be performed whilst the heating cable is located in situ in a heating arrangement.

The current may be applied to heat said conductor during the manufacture of the heating cable.

The heating element may comprise a semiconductor.

The heating element may comprise a polymeric matrix.

According to a second aspect, the present invention provides a heating cable processed by the above method.

Embodiments of the present invention will now be described, by way of example only, with reference to the accompanying drawings, in which:

FIG. 1 is a partially cut away perspective view of a known self-regulating heating cable;

FIG. 2 is a schematic representation of the equivalent circuit provided by the heating cable of FIG. 1;

FIG. 3 is a schematic representation of the equivalent circuit of the heating cable of FIG. 1, modified in accordance with an embodiment of the present invention; and

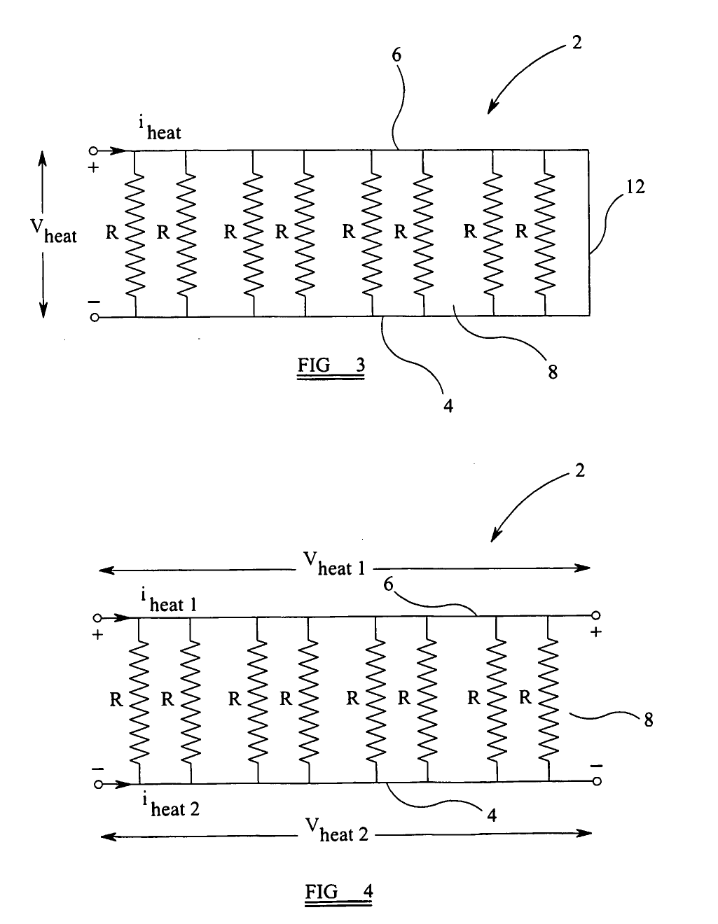

FIG. 4 is a schematic representation of the equivalent circuit of the heating cable of FIG. 1, modified in accordance with a further embodiment of the present invention.

The present inventors have realised that it is possible to improve the bond between a conductor and the heating element in a parallel resistance heating cable by applying a current along the conductor. The current is utilised to raise the surface temperature of the conductor (i.e. the portion of the conductor in contact with the heating element) to a temperature (the thermal transition point) that allows plastic flow of the material of the heating element. Plastic flow is when the material undergoes a change due to the material flowing (moving) in some way. Typically, plastic flow will occur at a temperature less than the melting point.

The portion of the heating element in contact with the conductor can thus move, allowing the bond between the conductor and the heating element to be reformed. Such a process can thus be utilised to repair heating cable that has a performance less than optimum i.e. if the cable has decreased in performance (the heat output at a predetermined voltage is less than desired) or failed.

A particular advantage of this type of technique is that only access to the ends of the heating cable is required—thus heating cable can be repaired in situ, without having to remove the cable from its installation.

Determination that the performance of the heating cable and/or that the bond between the heating element and at least one of the conductors is less than optimum may be realised in a number of ways. For instance, the heat output by the cable for a given voltage at a predetermined temperature may be determined to have decreased. Alternatively, it may be realised that a length of the heating cable is outputting less heat than other areas (or indeed, no heat at all), potentially due to a local decrease in the bond between the heating element and at least one of the conductors.

Alternatively, tests may be conducted that provide an indication of the condition of the bond between the heating element and the conductors. For instance, a measure may be made of the resistance between the conductors at a first voltage applied across the conductors, and at a second, different, voltage applied across the conductors.

For example, a relatively low voltage (e.g. 5 volts) may be applied across the two conductors, and the corresponding resistance Rₚₐₛₛᵢᵥₑ between the conductors measured. A second, higher voltage (e.g. the operating voltage, such as 230 volts) may then be applied across the conductors, and the corresponding resistance R_{active} between the conductors measured.

The ratio Rₚₐₛₛᵢᵥₑ/R_{active} can be used as an indication of the bond between the heating element and the conductors. Acceptable values for the ratio will vary depending upon the voltages at which the resistances are measured, as well as the type of cable, and the application (including desired performance) of the cable. Typically, a ratio Rₚₐₛₛᵢᵥₑ/R_{active} in the range of 1 to 1.5 indicates the bond is acceptable, with larger values indicating that the bond is unsatisfactory. R_{active} is normally smaller than Rₚₐₛₛᵢᵥₑ, as at higher voltages arcing will occur across poor connections, increasing the current flow and thus decreasing the apparent resistance.

FIG. 3 illustrates how the heating cable may be arranged to be processed in accordance with an embodiment of the present invention. FIG. 3 illustrates the modified effective functional circuit of the heating cable. The circuit is generally similar to the circuit illustrated in FIG. 2, with the addition of a conductor 12 connecting the two power conductors 4, 6. The conductor 12 is utilised to connect an end of a power conductor 4 to a respective end of the other power conductor 6, such that the two power conductors are in series. A current iₕₑₐₜ is then applied along the two power conductors 4, 6. The current iₕₑₐₜ can be conveniently applied by applying a voltage Vₕₑₐₜ across the unconnected ends of the power conductors 4, 6. As the conductors 4, 6, 12 have a relatively low resistance compared with the heating element 8, the current iₕₑₐₜ will be relatively large. The current iₕₑₐₜ will thus act to momentarily heat the conductors 4, 6 to the desired temperature e.g. with the surface of the conductors 4, 6 reaching a temperature greater than the thermal transition point (e.g. the melting point) of the heating element in contact with the respective conductor.

It will be appreciated that the precise voltages (and hence currents) applied to the conductors 4, 6 as well as the time periods for which the power is applied, will vary depending upon the length, cross section and materials. For instance, the current iₕₑₐₜ may only need to be applied for a relatively short time period for a polyethylene matrix heating element e.g. 230 volts for between 0.1 and 60 seconds, and preferably less than 5 seconds. However, it will be appreciated that for other materials, other heating time periods and other voltages (e.g. ranging from between 0.1-1000 volts) can be utilised. If desired, the magnitude of the heating current may be increased (or decreased) over a period of time. However, for most applications, it has been determined that a better bond is formed between the conductors and the heating element if a relatively high energy pulse is applied to the conductors for a brief period of time.

The current has to be applied for a sufficient period of time and has to be of sufficient magnitude to heat the conductors 4, 6 so as to allow plastic flow of the contacting heating element 8, without substantially damaging the conductors, or indeed any other elements of the cable. For instance, the current may be applied so as to melt at least the contacting surface of the heating element 8.

Subsequently, the heating cable is preferably allowed to cool, before being retested or operated. For instance, for a polyethylene matrix heating element, the cable is allowed to cool slowly to close to the ambient temperature before the cable is re-tested or operated. For some materials, it is desirable to control the rate at which the cable is cooled, so as to ensure the best possible bond between the heating element and the conductors. This controlled cooling may be formed in a number of ways. For instance, the hearing voltage Vₕₑₐₜ (and hence the heating current) may be decreased over a period of time, in a predetermined manner (including both continuous and step functions, so as to control the rate at which the cable cools. Alternatively, the temperature of the surroundings of the cable may be controlled so as to control the rate at which the cable cools. For instance, if the cable is fixed to a pipe, then the temperature of the fluid along the pipe may be regulated so as to control the cooling rate of the cable. Alternatively, if the cable is embedded within a floor, then the temperature of the floor may be controlled. This cooling period allows a good bond to be formed between the heating element and conductors.

In the above embodiment, the heating of the conductors 4, 6 has been described as a technique for improving the bond between the conductors and the heating element in a formed heating cable. However, the present inventors have realised that such a process can also be applied during the manufacture of the heating cable. During the manufacturing process, the heating element is typically extruded over the power conductors. In order to ensure a good bond between the conductors and the molten plastic during extrusion, the conductors are typically pre-heated to substantially the plastic melt temperature. Preferably the conductors are heated to be within 40° C. or even within 10° C. of the melt temperature, but more preferably to within 5° C., or even more preferably to within 1° C. Such heating is normally performed by an external heater.

However, it has been realised that the above process of heating the conductors by applying a voltage to the conductors can be utilised as either the sole method of heating the conductors, or a supplementary method of heating the conductors to the desired temperature. This is particularly useful for manufacturing heating cables comprising heating elements which have a relatively high melt temperature. For instance fluoropolymers have a melt temperature of approximately 280° C. Using the conventional heating technique, it is often difficult to raise the conductors to a high enough temperature to match the extrudate temperature at the desired production speeds. However, the process in accordance with the embodiments of the present invention can be used as an aid to raise the temperature to the desired level, and hence produce an improved bond. The quality of the resulting bond can be tested as described above, by measuring the resistance between the cables at two different applied voltages.

It will be appreciated that the above embodiments are described by way of example only, and various other embodiments will be apparent to the skilled person.

For instance, whilst the above embodiments have been described in which the heating cable comprises two parallel conductors, it will be equally appreciated that the present invention can be applied to heating cables comprising any number of conductors.

Equally, whilst in the above embodiments, the conductors were connected in series prior to the heating current iₕₑₐₜ being applied to both conductors 4, 6, it will be appreciated that the heating current may be applied in other manners. For instance, if desired, the heating current could be applied to only one of the conductors within the heating cable. Alternatively, as illustrated in FIG. 4, heating currents iₕₑₐₜ₁ and iₕₑₐₜ₂ may be applied separately along each conductor 4, 6 e.g. by applying a respective voltage Vₕₑₐₜ₁, Vₕₑₐₜ₂ across the length of each conductor 4, 6. Such currents iₕₑₐₜ₁, iₕₑₐₜ₂ could be applied at the same time, or sequentially. It is envisaged that typically Vₕₑₐₜ, =Vₕₑₐₜ₂. Such separate heating of the individual conductors is advantageous in allowing a lower power source to be used to provide the heating current. For instance, if the installation of cable is extremely long, then a relatively high power source may be required to provide the desired heating current if both the conductors are connected in series, with a relatively robust electrical connection required between the power source and the conductors. However, if the conductors are heated separately, then a lower power source can be utilised with less stringent connection requirements between the conductors and the power source.

1. A method of processing a parallel resistance heating cable, the cable comprising a heating element connected between at least two longitudinally extending conductors, the method comprising;
applying a current along at least one of said conductors, such that the surface temperature of the conductor is raised by ohmic heating to at least substantially the thermal transition point that allows plastic flow of the heating element.

2. A method as claimed in claim 1, wherein a current is applied along each of said conductors so as to raise the surface temperature of each conductor to at least substantially the thermal transition point of the heating element.

3. A method as claimed in claim 2, the method comprising connecting said conductors in series prior to applying said current.

4. A method as claimed in any one of the above claims, wherein said current is applied so as to elevate the surface of said conductor to a temperature greater than the thermal transition point of the heating element.

5. A method as claimed in any one of the above claims, wherein the current is applied for a time period of between 0.1 and 60 seconds.

6. A method as claimed in any one of the above claims, wherein the method further comprises the step of allowing the cable to cool to substantially ambient temperature after the application of said current.

7. A method as claimed in any one of the above claims, further comprising the step of monitoring the integrity of the bond between the conductors and the heating element by determining the resistance between the conductors when at least two different voltages are applied across the conductors.

8. A method as claimed in any one of the above claims, the method further comprising the step of determining that the performance of the heating cable is less than optimum.

9. A method as claimed in any one of the above claims, wherein said method steps are performed whilst the heating cable is located in situ in a heating arrangement.

10. A method as claimed in any one of claims 1 to 8, wherein said current is applied to heat said conductor during the manufacture of the beating cable.

11. A method as claimed in any one of the above claims, wherein the heating element comprises a semiconductor.

12. A method as claimed in any one of the above claims, wherein the heating element comprises a polymeric matrix.

13. A heating cable processed by the method as claimed in any one of the above claims.

14. A method of processing a heating cable substantially as hereinbefore described with reference to FIGS. 1 to 4 of the accompanying drawings.

15. A heating cable processed by the method substantially as hereinbefore described with reference to FIGS. 1 to 4 of the accompanying drawings.
